(19) United States
(12) Patent Application Publication
(10) Pub. No.: US 2004/0101811 A1
(43) Pub. Date: May 27, 2004

(54) Mechanical dally coach

(76) Inventor: Tommie C. Gipson, Eastland, TX (US)

Correspondence Address: Elizabeth R. Hall & Associates, P.C., 1722 Maryland Street, Houston, TX, 77006, US

(21) Appl. No.: 10/301,121

(22) Filed: Nov. 21, 2002

(51) Int. Cl. G09B 9/00; G09B 19/00; A63B 69/00

(52) U.S. Cl. 434/247

(57) ABSTRACT

A device for training a user to dally having a horse assembly, a track assembly, a cow head assembly, a pulling mechanism and a release mechanism. Whenever the release mechanism is activated by the user, the cow head assembly moves away from the user along the track assembly. During the cow head's movement, the user can practice roping and dallying. The training device may optionally have a rewind mechanism to allow the user to return the cow head assembly to its initial location without the user having to dismount the horse assembly.

### BACKGROUND OF THE INVENTION

1. Field of the Invention

The present invention relates to a method and apparatus for teaching a user to dally; and more particularly, to an apparatus that can be programmed to disengage at a predetermined stress load to allow a user to safely learn the sport of team roping.

2. Description of the Related Art

Team roping is a rodeo event that has become extremely popular in the United States, as well as other countries. Competitors can find all levels of competition available to them from local amateur events, to youth, high school, college, and professional rodeos. Additionally, team roping still finds its use on working cattle ranches for branding and doctoring cattle.

Team roping pairs two ropers, the header and the heeler. The ropers use ropes that are not attached to their saddles. In order to secure the ropes to the saddle after roping the animal, each roper wraps the end of their rope around their saddle-horn. The wrapping of the rope around the saddle-horn is called dallying. The header ropes the horns or head of the animal, and then dailies and the header's horse turns the steer off to the side. The heeler follows behind the steer and ropes the hind feet. Once the feet are caught, the heeler dailies and the ropes between the horses hold the steer. On a ranch, the ropers or a ground crew would then brand or doctor the animal. At a roping competition, the time is stopped when the ropes become taut, and the animal is then released.

For ropers, dallying is a skill that must be done correctly. Rodeo roping events typically use cattle weighing several hundred pounds, and horses weighing 1000 to 1500 pounds. After roping the steer, the roper must dally while the steer is moving away, pulling the rope through the roper's hand. If the roper does not position his/her hand correctly, or takes a wide wrap leaving slack around the saddle-horn, the roper may find his/her hand caught in the dally. Once a hand or finger is caught in the dally, there is little the roper can do to save their appendage from being severely injured or even amputated.

The activity of roping and dallying from horseback is a complex activity that involves control of the horse, anticipation of the actions of the animal being roped, and considerable manual dexterity. Accordingly, there is a need for a method and apparatus that allows beginning ropers to correctly and safely learn to dally, as well as allowing more experienced ropers to practice, under conditions that accurately simulate team roping.

### SUMMARY OF THE INVENTION

The present invention is a method and apparatus for training a user to dally. The mechanical dally coach of the present invention has been developed in order to solve the difficulties presented in attempting to realistically simulate specific conditions the roper will face during roping without risking injury to the roper's appendages.

The mechanical dally coach pulls a rope through the user's hand at a predetermined speed to simulate the movement of a roped steer moving away from the user's horse. The speed may be adjusted from a slower speed for a beginner to a faster speed for a more experienced user. The user pulling a rein simulating a roper slowing a horse after roping the steer starts the apparatus.

The apparatus' drive begins running immediately upon activation, so that when retraction of the rope begins there is not a gradual increase of retraction velocity, but rather an immediate, constant force retraction of the rope; more accurately simulating a realistic roping environment. The drive is disengaged after dallying and the rope becoming taut so the drive does not continue to try to retract the rope. The force necessary to disengage the drive member may be adjusted. It should be understood that the materials, size and means of the invention may vary based upon the performance goals for the device for training a user to dally.

One aspect of the invention includes: (a) a horse assembly comprising a frame, a simulated horse head with a bit and a rein attached to the bit, a brake release mechanism in communication with the bit, a winch assembly having a winch cable selectably wound around a winch drum, and a brake assembly that prevents the winch cable from unwinding from the winch drum; (b) a pulling mechanism including a weight tower, a weight suspended in the weight tower, and a pulling cable connected to the weight; (c) a pivot arm having a front and a back end, wherein the front end is attached to the frame of the horse assembly; (c) a track assembly having a first end attached to the back end of the pivot arm and a second end attached to the weight tower; and (d) a simulated cow head assembly reciprocably movable between the first and second ends of the track assembly, the cow head assembly attached to the winch cable on one end and to the pulling cable on an opposed end; whereby when the bit is pivoted by a pulling force applied to the rein, the brake release mechanism disengages the brake assembly to allow the winch cable to unwind and the cow head to move towards the weight tower being pulled by the pulling cable and the weight.

The invention may optionally include a rewind mechanism having: a rewind lever pivotable between a first and second position; a motor assembly connected to the winch assembly such that the winch cable is wound around the winch drum whenever the motor assembly is activated; a motor engagement cable connected to the rewind lever on one end and to the motor assembly on a second end, wherein when the rewind lever is in the second position the motor assembly is activated and when the rewind lever is in the first position the motor assembly is inactivated; and a link connecting the motor assembly and the brake assembly such that when the motor assembly is activated the brake assembly is disengaged.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a side view of one embodiment of the mechanical dally coach of the present invention.

FIG. 2A is a plan view of the embodiment of FIG. 1 as configured for a right-handed roper.

FIG. 2B corresponds to FIG. 2A, but is configured for a left-handed roper.

FIG. 3 shows a side view of the horse assembly and the pivot arm in a partial longitudinal section.

FIG. 4 is a schematic view of the drive assembly of the horse assembly, wherein the positions of the components are changed from the actual layout in order to better illustrate their operation.

FIG. 5 is a partial vertical section on the axis of the winch assembly.

FIG. 6 is a vertical transverse cross-section of the pivot arm near its end taken along line 6-6 of FIG. 3.

FIG. 7 is a vertical longitudinal cross-section of the driving end of the mechanical dally coach of the present invention taken along line 7-7 of FIG. 2B.

FIG. 8 is a side profile view of the cow head assembly.

FIG. 9 is a transverse sectional view of the cow head assembly taken along 9-9 of FIG. 8.

FIG. 10 is a transverse view of the cow head assembly in position on the track assembly.

FIG. 11 is a transverse view of the dual sheave of the present invention taken along line 11-11 of FIG. 3.

FIG. 12 is a transverse view of the dual sheave of the present invention taken along line 12-12 of FIG. 3.

### DESCRIPTION OF THE PREFERRED EMBODIMENTS

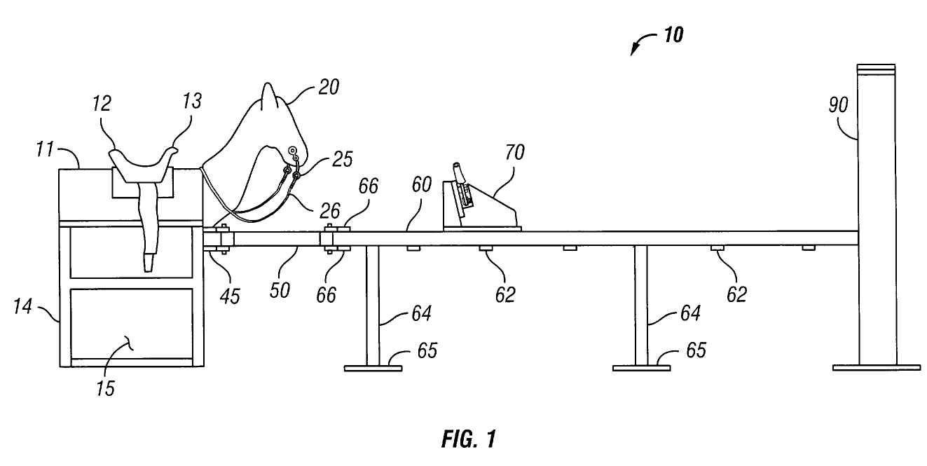

Referring now to the drawings and initially to FIG. 1, it is pointed out that like reference characters designate like or similar parts throughout the drawings. The Figures, or drawings, are not intended to be to scale. For example, purely for the sake of greater clarity in the drawings, wall thickness and spacing are not dimensioned, as they actually exist in the assembled embodiment.

The present invention provides a method and apparatus for training a user to dally. The mechanical dally coach of the present invention has been developed in order to solve the difficulties presented in attempting to realistically simulate specific conditions the roper will face during roping without risking injury to the roper's appendages.

The mechanical dally coach pulls a rope through the user's hand at a predetermined speed to simulate the movement of a roped steer moving away from the user's horse. The speed may be adjusted from a slower speed for a beginner to a faster speed for a more experienced user. The user pulling a rein simulating a roper slowing a horse after roping the steer starts the apparatus.

The apparatus' drive begins running immediately upon activation, so that when retraction of the rope begins there is not a gradual increase of retraction velocity, but rather an immediate, constant force retraction of the rope; more accurately simulating a realistic roping environment. The drive is disengaged after dallying and the rope becoming taut so the drive does not continue to try to retract the rope. The force necessary to disengage the drive member may be adjusted. Thus, the present invention provides a safe simulated environment to practice roping and/or dallying an animal.

To initiate a training practice, the rider is mounted on a stationary simulated horse and a facsimile of a cow head is selectably released to permit the head to travel away from the rider. The head may be previously roped or the user may prefer to practice roping and dallying the simulated cow head. The mechanical dally coach provides an environment representative of the actions required with actual live animals. The rider, while seated, can also selectably return the cow head to its starting position to initiate another roping and/or dallying practice run.

There are two adjustable safety mechanisms for preventing injury to a hand caught between the saddle horn and the rope during dallying. The first safety mechanism is built into the cow head, whereby the rope loop is automatically released from the cow head upon a predetermined amount of tension in the rope. The second safety mechanism is an adjustable pulling means, whereby the rate of travel of the cow head and the maximum tension in the rope is adjustable.

FIG. 1 is a side view of a preferred embodiment of a mechanical dally coach 10. The mechanical dally coach 10 comprises a mock horse assembly 11, a pivot arm 50, a track assembly 60, a cow head assembly 70 and a pulling device 90.

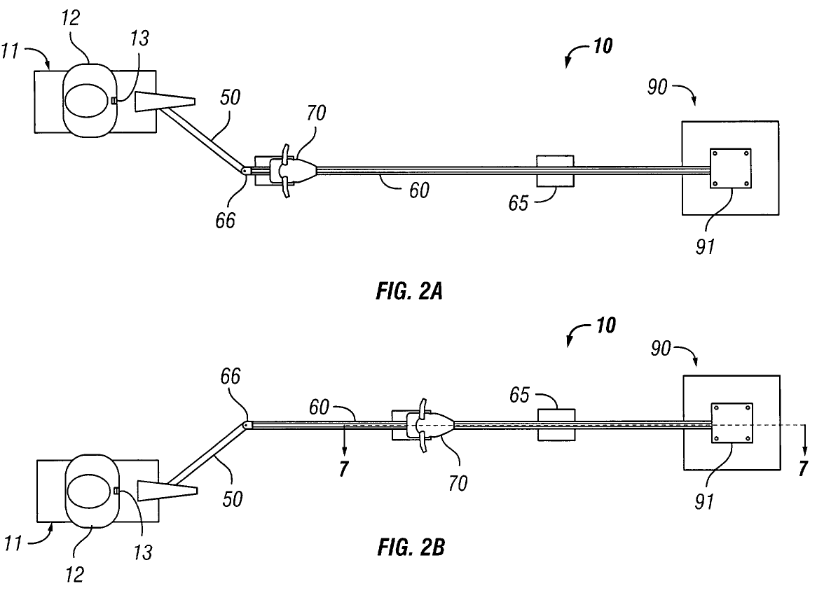

FIGS. 2A and 2B are plan views of the mechanical dally coach 10 that illustrate that the component assemblies of the present invention can be repositioned readily in order to provide different travel paths for the cow head relative to the position of the rider. This adjustability permits configuring the overall system for either left-handed or right-handed riders. FIG. 2A corresponds to a preferred position for a right-handed roper, while FIG. 2B shows the preferred position for a left-handed roper.

The mock horse assembly 11, shown in FIG. 1, has a saddle 12 with a saddle horn 13 and a horse head assembly 20 with a bit 25 and reins 26. The horse assembly 11 is either provided with a conventional western or Mexican saddle, or built so that a saddle can be strapped to the back of the horse assembly 11 to allow the user to practice dallying using his/her own saddle.

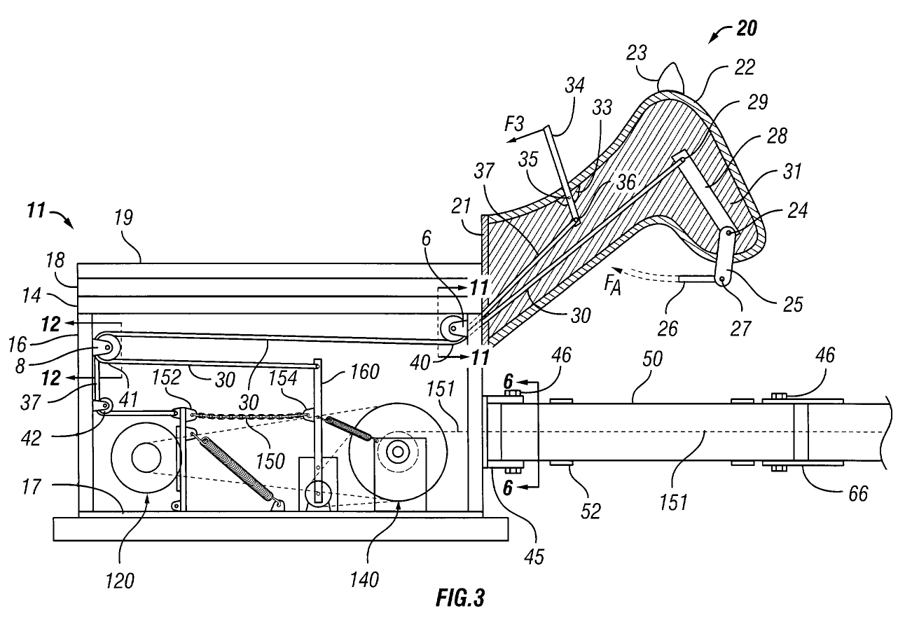

As shown in FIG. 1, a structural frame 14 for the horse assembly 11 has a protective cover plate 15 on each side to limit personnel access. FIG. 3 shows a longitudinal section of the horse assembly 11 with the saddle 12 and the cover plate 15 removed for clarity. The structural frame 14 of the horse assembly 11 consists of four legs 16, a rectangular floor plate 17 upon which the legs are mounted vertically at the plate corners, and two arcuate cross bars 18 respectively joining the front and rear pairs of legs 16. The cross bars 18 are symmetrically arched upwardly in the middle to provide a configuration similar in size and shape to the back of a horse. Multiple support planks 19 run longitudinally along the top of the structural frame 14 to provide a mounting base for saddle 12. The ends of the support planks 19 are attached, by screws or other attachment means known in the art, to the structural frame 14 where the support planks 19 are supported by the cross bars 18.

The horse head assembly 20 is typically made in the shape of a horse's head. It may be made of welded metal as described below or from a combination of metal and molded plastic to look more like a horse. The horse head assembly 20 has a transverse vertical horse head bulkhead 21 by which the assembly is symmetrically mounted to the structural frame 14 by welding.

Bulkhead 21 is either a rectangle or a trapezoid symmetrical about a vertical midplane. Bulkhead 21 has a clearance hole located on its vertical centerline in the middle of its lower end. A horse head perimeter plate 22 is bent to have a shape roughly corresponding to the profile of a horse head and has its transverse ends welded to bulkhead 21. If bulkhead 21 is rectangular, then perimeter plate 22 has constant width. If bulkhead 21 is trapezoidal, then the perimeter plate 22 is varied in width so that it has planar transverse edges after it is bent into its horse shape. A rectangular hole elongated in the direction of the horse neck is located on the centerline of the horse head perimeter plate 22 so that it will lie at approximately the middle of the upper horse neck.

The transverse sides of the horse head assembly 20 are covered with identical lateral skins 31 which have edges which conform to the horse neck profile of perimeter plate 22 and which are welded to the respective edges of plate 22 and to bulkhead 21. Steel plate ears 23 are welded to the lateral skin plates 31 for making the head assembly more realistic.

A release mechanism is typically connected to the reins 26, such that when the reins 26 are pulled by the roper the brake is released and the pulling mechanism is activated so that the cow head assembly 70 begins to move. One embodiment of the release mechanism includes a brake release cable activated by the rotation of a bit lever by pulling the reins 26 as described in more detail below.

Coaxial holes are located in the lateral skins 31 at the approximate position at which the crossbar of a bridle bit would be placed in the mouth of a horse. These holes serve to journal cylindrical bit shaft 24. Mounted transversely on the outer ends of bit shaft 24, exterior to horse head assembly 20, are identical flat bit bars 25. At the distal, lower ends of bit bars 25, leather or rope reins 26 are mounted to the bit bars 25 by means of rein attachment rings 27 engaged in holes in both the ends of the reins and the bit bars.

A first end of a transverse flat bar bit lever 28 is welded or otherwise attached to the middle of bit shaft 24. The second end of bit lever 28 has a hole for a cable attachment. Cable attachment 29 connects the brake release cable 30 to the second end of the bit lever 28. Sufficient room is provided inside horse head assembly 20 so that bit lever 28 can be rotated through an arc of up to 30° to 45° about the axis of bit shaft 24 whenever reins 26 are pulled manually by the roper on the horse assembly 11 to release the brake on the drive assembly and thereby initiate the movement of the cow head assembly 70 as described in detail below.

A rewind mechanism is optionally installed in the horse head assembly 20. The rewind mechanism allows a rider, while seated, to return the cow head to its starting position to initiate another roping and/or dallying practice run. A rewind lever mounting bracket 33 is a vertical metal plate tab welded to one lateral face of the upper neck and projecting inwardly into the interior of the horse head assembly 20.

Rewind lever 34 is a piece of steel flat bar which has a transverse hole intermediate in its length which is coaxial with a transverse hole in rewind lever mounting bracket 33. Pivot pin 35 is inserted through both the hole in the mounting bracket 33 and the intermediate hole in rewind lever 34. A transverse second hole 36 at the interior end of rewind lever 34 serves as an attachment point for the end of rewind cable 37. The outer end of lever 34 projects above the neck of the horse head assembly 20 where it can be readily manipulated manually by the roper mounted on the horse assembly 11.

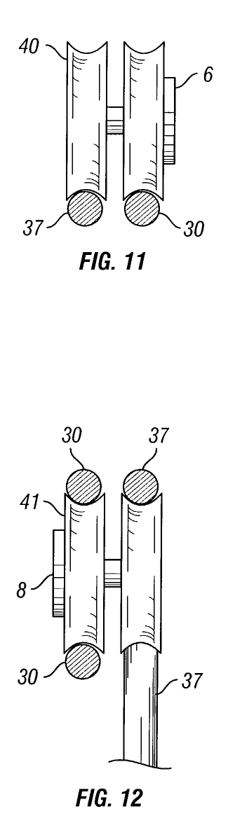

First turning sheave 40 is a dual sheave, as shown in FIG. 11, having a shaft transverse to the longitudinal vertical plane on the structural frame 14. First turning sheave 40 is mounted inside the perimeter of the frame 14 on a bracket 6 projecting horizontally inwardly between the front pair of legs 16 on the longitudinal centerline of the structural frame. Identical second dual turning sheave 41 is mounted with its shaft also transverse to the longitudinal vertical plane on the structural frame 14. Second turning sheave 41 is mounted inside the perimeter of the frame 14 on a bracket 8 projecting horizontally inwardly between the back pair of legs 16 on the longitudinal centerline of the structural frame. Third turning sheave 42 is a single sheave mounted with its shaft also transverse to the longitudinal vertical plane on the structural frame 14. Third turning sheave 42 is mounted inside the perimeter of the frame 14 on a bracket projecting horizontally inwardly between the rear legs 16 on the centerline of the structural frame.

As seen in FIGS. 3-4 and 11-12, the brake release cable 30 runs from its attachment at the cable attachment 29 of bit lever 28 through the hole in horse head bulkhead 21, over double sheaves 40 and 41, and then to the arm 161 of the brake release assembly 160. Thus, when the brake release cable 30 is pulled it moves the brake release arm 161 to disengage the braking mechanism.

Motor engagement cable 37, also shown in FIGS. 3-4 and 11-12, runs from rewind lever 34 through the hole in horse head bulkhead 21, over double sheaves 40 and 41, downwardly to sheave 42, and then to bracket 125 of the motor assembly 121. When the bracket 125 is pulled the motor assembly 121 is activated as described below.

A pivot arm 50 is used to reposition the components of the mechanical dally coach 10 in order to configure the system specifically for a left-handed or right-handed rider, as shown in FIGS. 2A and 2B. FIGS. 3 and 6 show the pivot arm 50 in detail.

The pivot arm 50 is attached at one end to a flat bar pivot bracket 45 on the structural frame 14. The pivot bracket 45 spans horizontally across the gap between the front legs 16 of the structural frame 14. Bracket 45 is symmetric about both its horizontal and vertical midplanes and has upper and lower symmetrical ears, each of which has a vertical pivot hole. A hole for the winch cable 151 is centrally located in the vertical face of bracket 45.

A preferred embodiment of pivot arm 50 is constructed primarily of two parallel steel C-channel sections 51 which have their flanges coplanar and inwardly facing. Multiple rectangular steel flat bar first tie plates 52 are lapped onto the outer surfaces of the pivot arm 50 to span from the flange of one channel 51 to the corresponding flange of the other channel and are welded to the flanges of the channels at various intervals along the lenghth of pivot arm 50 in order to interconnect the channels 51 as shown in FIG. 3. At the ends of the pivot arm 50 and channels 51, steel flat bar second tie plates 53 are connected between the adjacent top flanges and bottom flanges with butt welds as shown in FIG. 6. Symmetrically located transverse holes are positioned in the second tie plates 53 to serve as pivot holes.

At a first end of pivot arm 50 a pivot screw 46 in inserted into the hole of the upper ear of pivot bracket 45 on the horse assembly 11 and the vertical hole of the upper second tie plate 53, where nut 47 is used to retain the pivot screw 46. Similarly, at a first end of pivot arm 50 another pivot screw 46 in inserted into the hole of the lower ear of pivot bracket 45 and the vertical hole of the lower second tie plate 53, where another nut 47 is used to retain the pivot screw 46.

At end of pivot arm 50 closest to the horse assembly 11, a rectangular steel flat bar mounting plate 54 is welded horizontally between the webs of the channels 51, as seen in FIG. 6. A pair of vertical axis through holes is symmetrically placed about the vertical midplane of each mounting plate 54 in order to mount a pair of sets each consisting of a shoulder screw 55, a sheave 57 journaled on the shoulder screw 55, and a retaining nut 56. The spacing of the holes in the mounting plates 54 is such that the winch cable 151 can be accommodated between and retained by the pairs of sheaves 57. This arrangement permits the cable 151 to be guided and turned by the sheaves 57. Additionally, provision of the sheaves 57 accommodates varying fleet angles of the winch cable 151 as it is wound on and unwound off of the winch drum 148 of the winch assembly 140.

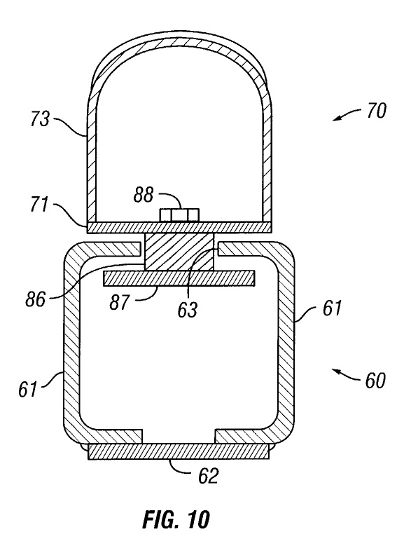

The structure of track assembly 60 is shown in FIGS. 1, 3, 7 and 10. Track assembly 60 consists primarily of two parallel identical steel C-channels 61 of constant cross-section and having coplanar inward facing flanges. The distance between the outside of the upper and lower flanges of the channels 61 is the same or slightly larger than that of the channels 51 of the pivot arm 50. As shown in FIG. 10, the channels 61 are spaced apart and interconnected by means of transversely positioned rectangular tie plates 62 which are lapped onto the bottom flanges of the channels and welded there so that a constant width slot 63 is created between the upper flanges.

One or more vertical rectangular cross-section hollow steel posts 64, as shown in FIG. 1, is centrally mounted on a rectangular steel foot plate 65 and attached to the track assembly 60 at the bottom of the pair of channels 61 at appropriate spacings to support the track assembly 60 at an appropriate height above the ground. The centerline height at which the track assembly 60 is supported by posts 64 and foot plates 65 are the same as that of the mounted pivot arm 50.

At the end of track assembly 60 closest to the horse assembly 11, identical rectangular upper and lower pivot support plates 66 are symmetrically lapped onto and welded to, respectively, the upper and lower flanges of channels 61 as seen in FIG. 3. The width of pivot plates 66 is such that they do not extend beyond the webs of the channels. The plates 66 do extend in the direction of the axis of track assembly 60 beyond the end of the channels 61. Each plate 66 has a coaxial vertical axis hole located centrally in the unattached portion of the plate.

Pivot arm 50 is connected to track assembly 60 in a similar manner as it is connected to the horse assembly 11 as illustrated in FIG. 6. A pair of bolts 46, each with nut 47, and each engaged through the corresponding vertical holes in pivot support plates 66 of the track assembly and the second tie plates 53 connect pivot arm 50 to track assembly 60 at the second end of the pivot arm 50. Furthermore, the second end of the pivot arm 50 has a sheave mounting plate 54 and sheaves 57 as described above for the first end of the pivot arm 50.

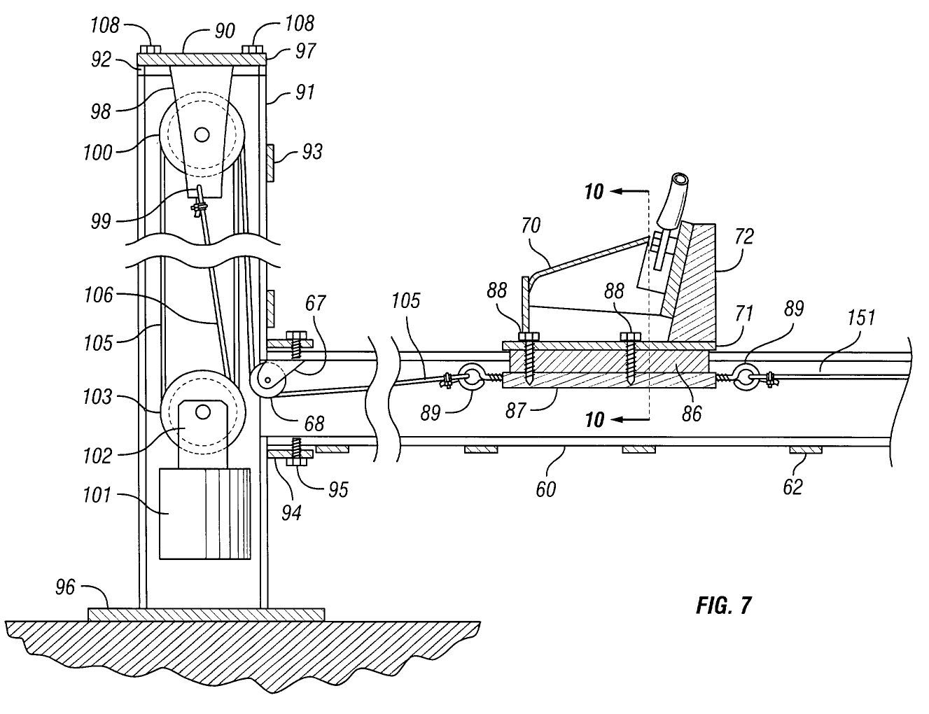

Adjacent the end of track assembly 60 distal from the horse assembly 11, as seen in FIG. 7, are located coaxial vertical axis tapped holes in the upper and lower flanges of channels 61. These holes are for the attachment of weight tower 90 to the track assembly.

Mounted by welding on the interior of the lower side of the upper flanges of channels 61 at the distal end of track assembly 60 is turning sheave bracket 67. Turning sheave bracket 67 consists of a transverse steel flat bar having symmetrically mounted spaced apart identical plate ears projecting downwardly and away from the horse assembly 11. The ears of turning sheave bracket 67 have coaxial holes positioned transversely to the vertical midplane of track assembly 60, such that when turning sheave 68 is mounted by means of its shaft, as seen in FIG. 7, a portion of the groove of sheave 68 extends within the interior of weight post 90.

Cow head assembly 70 is shown in FIGS. 7, 8, 9, and 10. The general shape and size of cow head assembly 70 corresponds to that of a beef cow or steer, including the horns, which are roped by the roper so that the rope is tightened around the head of the cow head immediately under the horns, thereby giving a good grip on the cow head assembly. The cow head assembly 70 is typically approximately 9 inches wide, excluding the horns, 10 inches high above the track assembly 60, and about 14 inches long. The constructed cow head assembly 70 is configured to be smoothly contoured so that the rope will not have unintended catch points, but will freely slide up under the horns if the loop lands below horn level. This facilitates the release of the rope at the end of a practice run to avoid having the roper dismount to free the rope prior to another practice throw.

One embodiment of the cow head assembly 70 has horizontal rectangular steel base plate 71. Plate 71 is slidably positioned on the centerline of the upper exterior surfaces of the channels 61 of track assembly 60 as seen in FIGS. 7 and 10. Plate 71 has two vertical axis through holes on its centerline. Rear head support 72 is a upwardly arched steel plate symmetrical about the vertical center plane of the track assembly 60 and welded to the outboard sides of plate 71 on its lower edges. The rear transverse face of the head support 72 lies in a vertical plane, while the forward face lies in a plane inclined from vertical by about 15° at its upper end toward the horse assembly 11.

Head skin 73 is a steel plate that is upwardly arched symmetrically about the vertical center plane of the track assembly 60. The rear face of head skin 73 is stepped, with both faces lying in planes parallel to the plane of the forward face of rear head support 72. Head skin 73 has an approximately frustro-conical shape that is tapered to a smaller size on its forward end. Vertical front head support 74 has an upwardly arched shape symmetrical about the vertical center plane of the track assembly 60, vertical lower sides, and a horizontal bottom edge. The arch of front head support 74 corresponds to that at the forward end of head skin 73, to which support 74 is welded at their mutual intersection. Front head support 74 is welded on its lower horizontal edge to the upper surface of base plate 71.

Transverse horn mounting plate 75 has a shape symmetrical about the vertical center plane of track assembly 60 and a shape that closely matches the inclined forward planar edge of rear head support 72. The forward face of horn mounting plate 75 has two symmetrically placed drilled and tapped holes located near its top approximately 2 inches inboard from the edge. The rear planar face of horn mounting plate 75 is welded to the forward edge of rear head support 72. The rearmost inclined planar edge of head skin 73 corresponds to the outline of the perimeter of the forward planar face of plate 75 and the two parts are welded together at their intersection.

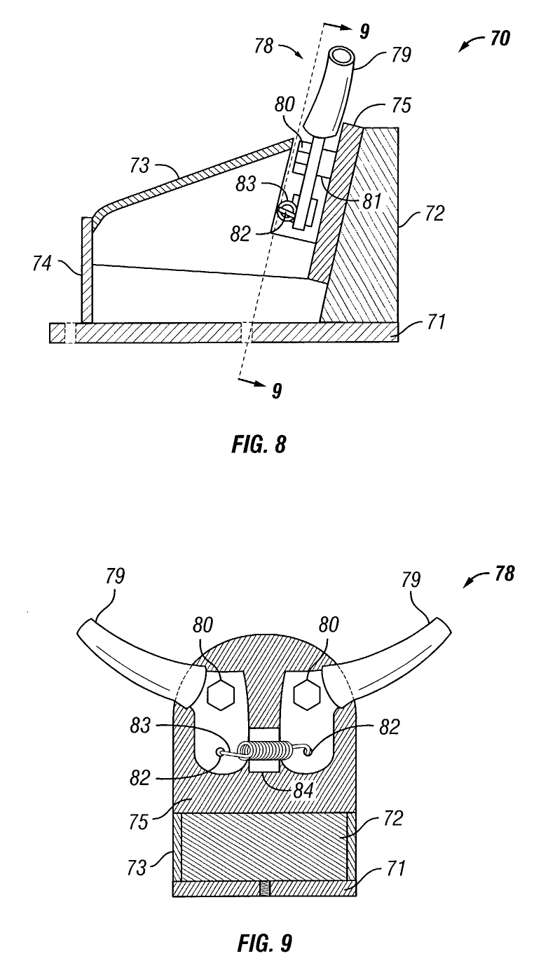

Horn assembly 78, as seen in FIGS. 8 and 9, is mounted on the inclined forward planar face of horn support plate 75. Horn assembly 78 consists of horns 79, horn pivot screws 80, spacer washers 81, spring mounting pins 82, tension bias spring 83, and horn travel stop 84. The horn assembly 78 is constructed in a manner such that it will stay in its initial alignment corresponding to that of a typical bovine until high rope loads applied upwardly parallel to its mounting plane on plate 75 cause it to deflect sufficiently so that the rope loop is released.

The pair of identical horns 79 are mounted in a mirror image pattern symmetrical about the vertical center plane of the track assembly 60 and, thus, also about the vertical center plane of the cow head assembly 70. Each horn is made of approximately 0.5 inch thick steel plate and has an outwardly projecting tapered and slightly curved horn leg approximately 9 inches long and approximately 2.5 inches wide at its large end. A second approximately rectangular reaction leg approximately 4 inches long by 2.5 inches wide projects at an angle of approximately 120° from the axis of the horn leg at the large end of the horn leg.

A transverse round pivot hole is located at the center of the intersection of the two legs of the horn 79 so that the horn can be pivoted about a horn pivot screw 80 inserted into the pivot hole and threadedly engaged in one of the tapped holes on the forward face of horn mounting plate 75. A flat washer 81 is coaxial with each horn pivot screw 80 and positioned between the horn 79 and the horn mounting plate 75.

A second transverse hole is located at the outer end of each reaction leg of the horn 79 for the mounting of a pressed-in cylindrical spring mounting pin 82 that extends outwardly from the forward face of the horn. The exposed end of spring mounting pin 82 has an annular groove for engaging a formed eye on the end of tension bias spring 83. Tension bias spring 83 is a conventional tension coil spring having an unclosed formed eye loop on each end. When installed with its formed eye loops over the spring mounting pins 82, the spring 83 is stretched so that it provides a bias force inwardly on the pins 82 that is predetermined by its design characteristics.

A rectangular steel plate horn travel stop 84 is welded vertical to horn mounting plate 75 in a central position between the horns and with its top approximately 1 inch below the level of the horn pivot screws 80. Horn travel stop 84 is made of 0.5 inch thick steel plate and is approximately 3.5 inches by 3.5 inches. Horn travel stop 84 is placed between the reaction legs of the horns 79 so that the reaction legs are pivoted to and maintained in a symmetrical vertical position by being biased against the travel stop 84 by the pretension on spring 83. Spring 83, travel stop 84, pins 82, washers 81, and pivot screws 80 are all housed within the cow head assembly 70 so that they are protected from and do not interfere with a throwing rope engaged with the cow head.

As shown in FIG. 7, immediately beneath and symmetrical with the head base plate 71 is a rectangular steel spacer plate 86. Spacer plate 86 extends the length of head base plate 71, is slightly thicker than the flanges of channels 61 of the track assembly 60, and is slightly narrower than the slot 63 formed between the channels 61 as shown in FIG. 10. Spacer plate 86 has two bolt clearance holes, which are coaxial with the holes in head base plate 71. Immediately beneath and symmetrical with spacer plate 86 is sole plate 87. Sole plate 87 is approximately 0.25 inches thick, as long as the spacer plate 86, and approximately 1 inch wider than the slot 63, but narrower than the interior flat formed by the inside of the upper flanges of channels 61 of track assembly 60. Sole plate 87 has two drilled and tapped holes coaxial with those of spacer plate 86 and head base plate 71 into which bolts 88 are threadedly engaged so that plates 71, 86, and 87 are clamped together to form a retentive guide structure on the base of cow head assembly 70.

A drilled and tapped hole located on the centerline of each of the forward and rear faces of sole plate 87 serves to threadly mount an eye screw 89 at each end of the cow head assembly 70. The winch cable 151 is attached to the rear eye screw so that the winch can selectably pull the cow head assembly back toward the horse assembly 11. The pulling weight cable 105 of the weight tower 90 is attached to the other eye to provide a constant bias force which tends to pull the cow head assembly away from the horse assembly 11.

The arrangement of the weight tower 90 is shown in FIG. 7, which is a vertical cross-sectional view of weight tower 90. The external structure of weight tower 90 is composed of two identical parallel C-channels 91 of constant cross-section that have their flanges facing inwardly. At the upper end of channels 91, a rectangular plate flange 92 with a large central clearance hole is welded to the channel ends. A drilled and tapped hole is located adjacent each corner of flange 92. The channels 91 are spaced apart and interconnected by means of transversely positioned rectangular tie plates 93 which are lapped onto the side flanges of the channels closest to the horse assembly 11 and welded there so that a constant width slot is created between the flanges.

The width of the slot is sufficient to accommodate insertion of the turning sheave bracket 67 and turning sheave 68 of the track assembly 60 when the weight tower is assembled to the track assembly. On the horse side of the weight tower 90 are placed two identical spaced-apart parallel horizontal attachment plates 94 which are welded to the flanges of the channels 91 on the side of the horse assembly 11. The vertical positioning of the attachment plates 94 is such that the upper plate slightly clears the top flanges of the channels 61 of track assembly 60 while the lower plate slightly clears the bottom flanges of the channels 61. Attachment plates 94 each have a pair of bolt clearance holes coaxial with the tapped holes in the weight tower ends of the channels 61. Screws 95 are inserted into the holes in plates 94 and threadedly engaged with the tapped holes of the channels 61 in order to interconnect the weight tower 90 with the track assembly 60. On the lower end of the channels 91 of the weight tower, rectangular tower base plate 96 is welded to the channel ends.

On the top of weight tower 90, lid 97 is a rectangular plate having the same external dimensions as flange 92 and bolt clearance holes in its corners in locations coaxial with the tapped holes of flange 92 so that, when lid 97 is placed on top of the flange, the two can be screwed together by screws 108. Welded to and projecting vertically downwardly from the bottom of lid 97 are two identical, parallel spaced-apart rectangular or trapezoidal plates that constitute stationary sheave bracket 98. The plates of bracket 98 are symmetrically positioned about the vertical longitudinal center plane of tower 90 and have coaxial shaft holes centrally located at approximately midlength. At the lower end of one or both of the plates of bracket 98 a transverse hole serves as cable anchor point 99. Multiple independently rotatable stationary sheaves 100 are mounted on their common cylindrical shaft in the shaft holes of bracket 98.

Head pulling weight 101 is typically a rectangular prismatic block of steel, lead, or cast iron that is freely vertically reciprocable within tower 90. The speed of travel of the cow head assembly 70 and the maximum force on the rope that a user is dallying is proportional to the weight of the head pulling weight 101.

Attached to the top of pulling weight 101 are two identical, parallel spaced-apart rectangular or trapezoidal plates that constitute traveling sheave bracket 102. The plates of bracket 102 are symmetrically positioned about the vertical longitudinal center plane of tower 90 and have coaxial shaft holes centrally near their upper ends. Multiple independently rotatable traveling sheaves 103 are mounted on their common cylindrical shaft in the holes of sheave 102.

The first end, termed the cable bitter end 106, of pulling weight cable 105 is anchored to the stationary sheave at cable anchor point 99. The cable 105 is then reeved alternately between the traveling sheaves 103 and the stationary sheaves 100, then from the final stationary sheave around the turning sheave 68 and thence into the interior of the track assembly 60, where it is attached to the forward eye screw 89 mounted on the cow head assembly 70.

The length of cable 105 is such that, when the cow head assembly 70 is positioned at its closest position to the horse assembly 11, the weight 101 is at its maximum elevation within the weight tower 90. In contrast, when the cow head assembly 70 is at its farthest position from the horse assembly 11, weight 101 is at its lowest position. At both extreme positions, some reserve vertical travel is provided for the weight 101.

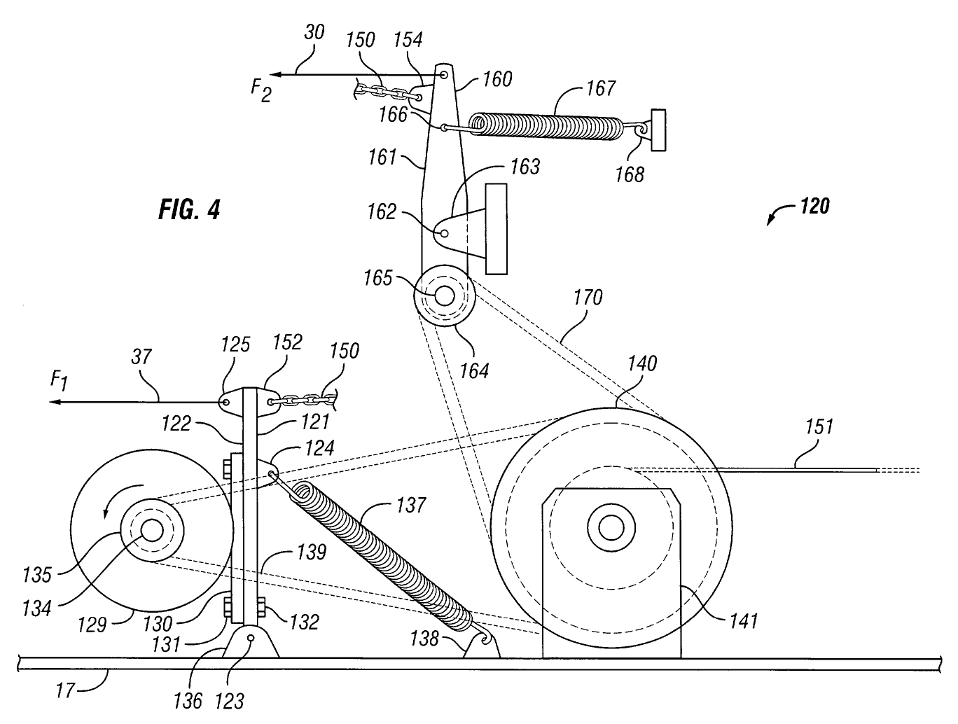

FIG. 3 shows the actual physical arrangement of the drive assembly 120, which is used to control the operation of the mechanical dally coach 10. The drive assembly 120 is mounted to the floor plate 17 within the perimeter of structural frame 14 and is isolated from the rider by cover plate 15. FIG. 4 shows the constituent components of drive assembly 120 in an altered pattern wherein the components of the brake release assembly 160 are artificially shifted in an upward direction in order to more clearly illustrate the interrelationship of the different subsystems of the drive assembly 120. The rearrangement in FIG. 4 of the brake bracket 163 of the brake release assembly 160, along with its associated pivot pin 162, upwardly from its actual location attached to the floor plate 17 of the structural frame 14 of the horse assembly does not impact the function of the mechanism shown. The drive assembly 120 consists of a motor assembly 121, a winch assembly 140, and a brake release assembly 160.

Motor assembly 121 consists of motor 129, a pivoting spring-biased motor mounting, and an attachment point for the motor engagement cable 37, which can selectably apply a counterforce to overcome the disengagement bias of the motor disengagement spring 137 and to tension chain 150. Motor mounting plate 122 is a vertical or close to vertical rectangular flat plate with its bottom edge parallel to floor plate 17 and which has opposed coaxial horizontal pivot pin holes in its midplane near its bottom edge. A close fitting cylindrical pivot pin 123 can be inserted in each pivot pin hole to permit motor mounting plate 122 to be swiveled about the axis established by the pivot pins. Motor mounting plate 122 also has a rectangular array of holes and or slots through the plate that can be used for positioning and attaching the motor 129 to the plate 122.

First spring mount 124 is a small vertical plate tab having a through hole for mounting one end of motor disengagement spring 137 through the hole. First spring mount 124 is welded on the side of the motor mounting plate 122 closest to the horse head assembly 20.

Bracket 152 is a small vertical plate tab having a through hole for mounting one end of the tension chain 150 through the hole. Bracket 152 is welded on the side of the motor mounting plate 122 closest to the horse head assembly 20. The second end of the tension chain 150 is mounted to bracket 154. Bracket 154, like bracket 152, is a small vertical plate tab having a through hole for mounting the second end of the tension chain 150 through the hole. Bracket 154 is welded on the side of the brake release arm 161 furthest from the horse head assembly 20.

Bracket 125 is a small vertical plate tab having a through hole for attaching the end of motor engagement cable 37. Bracket 125 is welded to the upper end of motor mounting plate 122 on the side opposed to that of the first spring mount 124. It is assumed that the tension in the motor engagement cable 37 is equal to F1. Rotary electric motor 129 is attached to a switched electrical supply so that it can be turned on or off selectably. The details of the electric supply are not shown but are conventional and well known.

The motor 129 has a mounting foot 130 that is parallel to the axis of the motor and offset therefrom. The mounting foot 130 is rectangular and has through mounting holes through which bolts 131 with their attendant nuts 132 can be inserted in order to position the motor on the mounting plate 122. The holes in the mounting foot 130 correspond to the holes or slots in motor mounting plate 122. Two identical vertical plate tab motor mounting brackets 136 and having pivot pin holes are positioned on and welded to floor plate 17 so that they can journal the pivot pins 123 in the motor mounting plate 122. The brackets 136 are spaced apart with their pivot pin holes are coaxial and the motor will have its axis normal to the vertical midplane of the structural frame 14.

Motor disengagement spring 137 is a conventional tension coil spring having an unclosed formed eye loop on each end. Second spring mount 138 is a vertical plate tab which is aligned to be coplanar with first spring mount 124 and is welded to floor plate 17. The two eye loops of motor disengagement spring 137 are engaged in the holes of spring mount 124 and 138. The spring 137 is selected to provide a sufficient bias force that, in the absence of external operating force applied to the motor assembly 121 by motor engagement cable 37, the motor assembly is strongly rotated in a clockwise direction as shown in FIG. 4 about pivot pins 123 and is disengaged.

Motor 129 has a horizontal output shaft 134 which mounts a grooved V-belt sheave 135. The position of the motor 129 on the motor mounting plate 122 is such that sheave 135 projects outwardly past the edge of the motor mounting plate 122. Winch belt 139 is a reinforced rubber V-belt deployed in the groove of motor sheave 135.

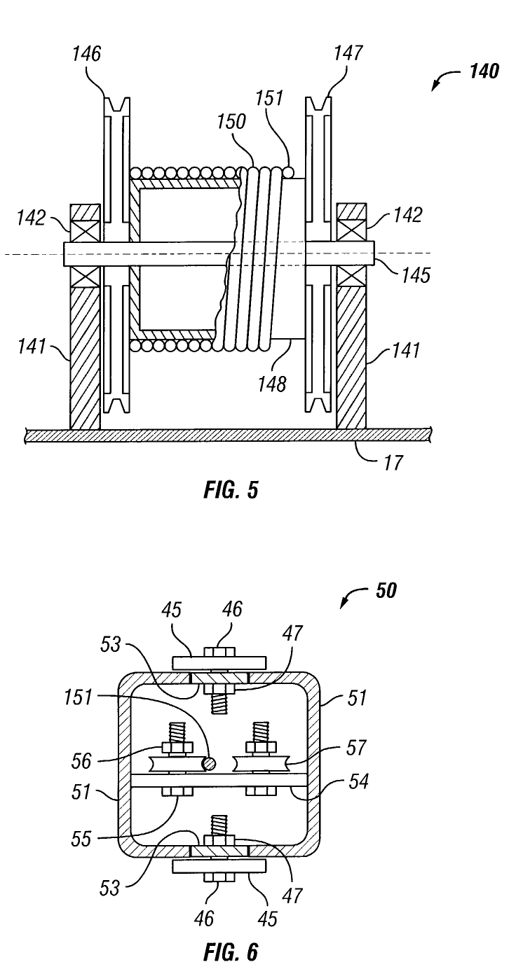

Referring to FIG. 5, a partial longitudinal cross-section of the winch assembly 140 is illustrated. Winch assembly 140 consists of pedestal plates 141, rotary bearing 142, winch shaft 145, drive sheave 146, brake sheave 147, and winch drum 148.

The identical winch pedestal plates 141 are rectangular plates with through mounting holes for conventional rotary bearings 142 centrally positioned near their upper ends. The winch pedestal plates 141 are mounted parallel to and spaced apart from each other on the floor plate 17 in order to accommodate the other rotary components of the winch assembly between them. The pedestal plates 141 are mounted parallel to the vertical longitudinal midplane of the horse assembly 11 and with their bearing mounting holes coaxially positioned.

The bearings 142 can be plain bearings, ball bearings, or roller bearings. Rotary shaft 145 is a cylindrical steel shaft journaled at both ends in bearings 142. The drive shaft is fixed to the drive sheave 146, the brake sheave 147, and the winch drum 148 to prevent relative rotation and axial movement between those components. Although FIG. 5 illustrates these components welded, rotational restraint may be a number of other means such as keyways or commercially available expandable annular bushings. Drive sheave 146 and brake sheave 147 are both commercially available conventional round, large diameter V-belt sheaves having peripheral annular grooves and a central shaft hole.

Winch drum 148 is a hollow right circular cylinder with transverse end diaphragms having identical coaxial holes located on the drum axis. Normally the transverse end diaphragms are extended radially beyond the diameter of the winch drum to serve as flanges for a winch drum. Here, the amount of cable 151 stored on the drum is sufficiently small and the biasing fleet angle of the cable entering the drum sufficient due to predetermined winch drum lateral placement relative to the horse assembly centerline exit path that flanges are not required. This use of a lateral offset of the cable from the winch drum also avoids the need for a levelwind mechanism. The winch drum 148 is provided with a conventional means for anchoring the end of winch cable 151 so that multiple wraps 150 of the cable can be wound upon the winch drum 148. The winch assembly 140 is positioned where its drive sheave 146 is coplanar with the motor sheave 135 of the motor assembly 121.

Brake release assembly 160 consists a brake release arm 161 that is a lever mounting a nonrotating sheave 164 at one end and biased in a first rotational direction by a biasing brake setting spring 167. The normal position of the brake release assembly 160 is to be biased by the spring 167 so as to retain an externally driven brake V-belt 170 within the groove of its nonrotating sheave 164 and to engage the belt 170 sufficiently to apply significant tangential forces to the belt in order to prevent rotation of the driving means of the belt 170. The brake is engaged until one of the following occurs: (1) the brake release cable 30 is tensioned by pulling back the reins 26, or (2) the rewind lever 34 is pulled thereby tensioning motor engagement cable 37 to engage motor 129 and to tension chain 150 sufficiently to overcome the biasing brake setting spring 167.

A brake release cable 30 is also attached to the brake release arm 161 to selectably apply vector force components whereby the bias forces of the spring 167 can be overcome to cause the nonrotating sheave 164 to cease to drag against the externally driven brake V-belt 170 and thereby permit the driving means of the belt to freely rotate. The brake release cable 30 is tensioned by pulling back on the reins 26 of horse assembly 11.

Likewise, the tension chain 150 is attached to the brake release arm 161 to selectably apply vector force components whereby the bias forces of the spring 167 can be overcome to cause the nonrotating sheave 164 to cease to drag against the externally driven brake V-belt 170 and thereby permit the driving means of the belt to freely rotate. The tension chain 150 is tensioned by pulling the rewind lever 34 thereby tensioning motor engagement cable 37 to pivot motor mounting plate 122 pulling on the tension chain 150 that will supply sufficient force on the brake release arm 161 to overcome the biasing forces of the brake setting spring 167.

Brake release arm 161 is an elongated segment of steel flat bar which has a centrally positioned through hole which serves as a fulcrum for the rotation of the brake release arm 161. Cylindrical pivot pin 162 is supported in the fulcrum hole of the brake release arm 161. Brake bracket 163 is a vertical plate tab having a through hole and is generally mounted to the floor plate 17 by welding. Bracket 163 is mounted parallel to the vertical midplane of horse assembly 11.

Nonrotating sheave 164 is rigidly mounted at the lower end of brake release arm 161 on a protruding sheave mount shaft 165 which is normal to arm 161 and rigidly fixed to that arm. The nonrotating sheave 164 is of standard commercially available V-belt sheave construction and is coplanar with the brake sheave 147 of winch assembly 140. A spring attachment through hole 166 is centrally located in brake release arm 161 near its upper end. At the extreme upper end of brake release arm 161 is located a through hole to which brake release cable 30 is attached.

The tension in brake release cable 30 varies from essentially zero to a force sufficient to overcome the aforementioned spring bias. For the purposes of discussion, the tension in the brake release cable 30 is F2. Brake setting spring 167 is a conventional tension coil spring having an unclosed formed eye loop on each end. Spring attachment mount 168 is a vertical plate tab aligned to be coplanar with the brake release arm 161 and is welded to floor plate 17.

Brake setting spring 167 has its two formed eye loops respectively engaged in the spring mount holes of brake release arm 161 and spring attachment mount 168. The spring 167 is selected to provide a sufficient bias force that, in the absence of external operating force applied to the brake release assembly 160 by brake release cable 30 or the tension chain 150, the brake release arm 161 is strongly rotated in a clockwise direction as shown in FIG. 4 about pivot pin 162. Brake belt 170 is a reinforced rubber V-belt deployed in the grooves of brake sheave 147 of the winch assembly 140 and nonrotating sheave 164.

With only spring bias force applied to brake release arm 161 by spring 167, the load applied to nonrotating sheave 164 is sufficient to produce strong radial force components on the brake belt so that considerable tangential friction is consequentially developed between the brake belt 170 and the nonrotating sheave 164. The bias force of the spring 167 is sufficient to overcome the rotational moment on the winch assembly induced by the head pulling weight 101 acting on pulling weight cable 105, cow head assembly 70, and winch cable 151.

Operation of the Mechanical Dally Coach

The present invention is operated in the following manner. The pivot arm 50 and the track assembly 60 with the attached weight tower 90 are positioned to the desired orientation relative to the horse assembly 11. Typically, the orientation corresponds to that of FIG. 2A, but other orientations are certainly practical, including those for which the cow head assembly 70 will travel at an angle to the longitudinal vertical midplane of the horse assembly.

Initially, the cow head assembly 70 is in its closest position to the horse assembly 11 and hence adjacent the horse end of track assembly 60. At this time, no tension is in brake release cable 30, so that the spring bias of brake setting spring 167 is sufficient to cause the frictional drag of nonrotating sheave 164 on the brake V-belt 170 to overcome the moment on the winch drum 148 from the weight 101-induced tension transmitted to the winch cable 151.

When the rider mounted on saddle 12 atop horse assembly 11 is ready to begin a practice session, the rider pulls the reins 26, thereby causing bit shaft 24 to rotate and tensing brake release cable 30 with tension F2. When sufficient pull is maintained on the reins 26 by the rider, then the bias of brake setting spring 167 is overcome and the brake belt 170 slips on both sheave 164 of the brake release assembly 160 and brake sheave 148 of the winch assembly.

At this point, the cow head is pulled forward toward the weight tower 90 by the tension induced in the pulling weight cable 105 by the pulling weight 101. At this point the rider can throw his loop at the advancing cow head assembly 70.

If the rope loop misses the cow head assembly, then the cow head assembly will continue moving to its end point adjacent the weight tower 90 unless the pull on the reins is released so that the brake on the winch is reset. The rider can then rewind the rope. In the event that the rope loop engages the cow head assembly 70 under the horns 79, the rope will tend to slip upwardly to the base of the horns as it is tensioned by the forward motion of the cow head assembly. Alternatively, the cow head assembly 70 may have been roped prior to releasing the cow head assembly to move forward.

In either case, the rider must rapidly establish a loop of his rope around the horn 13 of the saddle 12 and apply back tension to the rope. This last maneuver is known as dallying. Dallying the rope around the saddle horn 13 and applying back tension on the free end of the rope substantially multiplies the tension in the rope between the saddle horn and the cow head assembly 70. This constitutes a successful dally.

When the tension on the rope is sufficient from the successful dallying of the rope, the rope will slide upwardly against the horns 79 and exert considerable upward force against the horns. When the upward force on the horns exceeds the induced resistance of the horns to movement produced by the spring bias force from the tension bias spring 83, the horns 79 rotate together and the rope can slip off the deflected horns and escape. The roper can then rewind his rope.

During the entire operation, the tension developed in the rope by the dallying operation is insufficient to sever a finger or severely injure the rider. The mechanical dally coach 10 is designed with two limitations on the tension that can accumulate on the rope. The first limitation is the gravitational force developed by the head pulling weight 101 selected by the rider to be a safe level. The second limitation is the tension necessary to release the rope from the horns 79 that is preset to be a safe level.

Preparatory for another practice run, the rider pulls the upper end rewind lever 34 towards himself, thereby rotating lever 34 about pivot pin 35 and inducing tension F1 in motor engagement cable 37. When tension F1 is sufficient to overcome the bias of motor disengagement spring 137, the motor mounting plate 122 with motor 129 is rotated counter-clockwise, as seen in FIG. 4. The rotation of the motor tensions the winch belt 139 and the winch assembly 140 is driven by the belt to rewind the winch cable 151. Whenever the motor mounting plate 122 is rotated counter-clockwise the tension chain 150 is tightened sufficiently to activate the brake release mechanism 160 to prevent any braking action on the winch assembly 140.

When the cow head assembly 70 is sufficiently retracted, then the rider releases his pull on the rewind lever 34 of the horse assembly 11. The brake then arrests the tendency of the cow head assembly to rotate the winch assembly 140 and the rewinding driving force on the winch assembly is removed. At this point, the mechanical dally coach 10 is ready for another practice run.

Although the present invention and its advantages have been described in detail, it should be understood that various changes, substitutions and alterations can be made herein without departing from the spirit and scope of the invention as defined by the appended claims.

What is claimed is:

1. A device for practicing team roping, said device comprising:
a horse assembly;
a pulling mechanism;
a track assembly having a first end and second end, wherein the track assembly extends from the horse assembly at the first end to the pulling mechanism at the second end;
a simulated cow head assembly reciprocably movable along a length of the track assembly between the first and second ends of the track assembly; and
a release mechanism for initiating movement of the cow head assembly along the length of the track assembly toward the second end of the track assembly.

2. The device of claim 1, further comprising a rewind mechanism.

3. The device of claim 1, wherein the horse assembly includes a simulated horse head assembly with a bit and a pair of reins attached to the bit, wherein the reins communicate with the release mechanism.

4. The device of claim 1, wherein the horse assembly has a saddle with a horn.

5. The device of claim 1, wherein the horse assembly has a frame and a saddle mounting section on a top side of the horse assembly.

6. The device of claim 1, wherein the first end of the track assembly has a pivot arm.

7. The device of claim 1, wherein the simulated cow head assembly has a winch cable attached to a front side of the cow head assembly and a pulling cable attached to a back side of the cow head assembly.

8. The device of claim 7, wherein the pulling mechanism includes a weight, the weight attached to the pulling cable.

9. The device of claim 8, wherein the pulling force applied to the pulling cable by the pulling mechanism is adjustable.

10. The device of claim 1, wherein the cow head assembly includes a horn assembly, the horn assembly has two horns held apart by a separation means, wherein the separation means provides a first biasing force to separate the horns.

11. The device of claim 10, wherein the horns are moved closer together whenever a force is applied to the horns that is greater than the first biasing force.

12. The device of claim 1, wherein the pulling mechanism includes a replaceable weight suspended in a weight tower.

13. A mechanical dally coach comprising:
(a) a horse assembly comprising
a frame,
a simulated horse head with a bit and a rein attached to the bit,
a brake release mechanism in communication with the bit,
a winch assembly having a winch cable selectably wound around a winch drum, and
a brake assembly that prevents the winch cable from unwinding from the winch drum;
(b) a pulling mechanism including a weight tower, a weight suspended in the weight tower, and a pulling cable connected to the weight;
(c) a pivot arm having a front and a back end, wherein the front end is attached to the frame of the horse assembly;
(d) a track assembly having a first end attached to the back end of the pivot arm and a second end attached to the weight tower; and
(e) a simulated cow head assembly reciprocably movable between the first and second ends of the track assembly, the cow head assembly attached to the winch cable on one end and to the pulling cable on an opposed end;
whereby when the bit is pivoted by a pulling force applied to the rein, the brake release mechanism disengages the brake assembly to allow the winch cable to unwind and the cow head to move towards the weight tower being pulled by the pulling cable and the weight.

14. The mechanical dally coach of claim 13, wherein the horse assembly further comprises a rewind mechanism, said rewind mechanism having:
a rewind lever pivotable between a first and second position;
a motor assembly connected to the winch assembly such that the winch cable is wound around the winch drum whenever the motor assembly is activated;
a motor engagement cable connected to the rewind lever on one end and to the motor assembly on a second end, wherein when the rewind lever is in the second position the motor assembly is activated and when the rewind lever is in the first position the motor assembly is inactivated; and
a link connecting the motor assembly and the brake assembly such that when the motor assembly is activated the brake assembly is disengaged.

15. The mechanical dally coach of claim 13, wherein the cow head assembly includes a pair of horns mounted on the cow head assembly, said horn reciprocable between a first position where the horns are separated by a biasing force and a second position wherein the horns have been moved towards each other by a force applied to the horns that surpasses the biasing force.

16. The mechanical dally coach of claim 13, wherein the cow head assembly includes a horn assembly having two horns, the two horns separated by a biasing force.

17. The mechanical dally coach of claim 16, wherein the two horns are drawn together whenever a force is applied to the horns that exceeds the biasing force.

18. The mechanical dally coach of claim 13, wherein the weight is replaceable with one or more weights.

19. A mechanical dally coach comprising:
(a) a horse assembly including
(i) a frame,
(ii) a simulated horse head having a rotatable bit lever having a brake release cable attached to an interior end of the bit lever and a bit attached to an exterior end of the bit lever, the bit having a rein connected to the bit such that when the rein is pulled toward a back end of the horse assembly the interior end of the bit lever is rotated toward the front end of the horse assembly tensioning the brake release cable,
(iii) a brake release mechanism in communication with the brake release cable, wherein the brake release mechanism is activated when the brake release cable is tensioned,
(iv) a winch assembly having a rotatable drum and a winch cable, wherein a first end of the winch cable is attached to the winch drum, the winch cable being coiled about the drum when the drum is rotated in a first direction and being uncoiled when the drum is rotated in a second direction, and
(v) a brake assembly that prevents the drum from being rotated in the second direction, wherein the brake assembly is disengaged whenever the brake release mechanism is activated;
(b) a pulling mechanism including a weight tower, a weight suspended in the weight tower, and a pulling cable connected to the weight;
(c) a pivot arm having a front and a back end, wherein the front end is attached to the frame of the horse assembly;
(d) a track assembly having a first end attached to the back end of the pivot arm and a second end attached to the weight tower;
(e) a simulated cow head assembly reciprocably movable between the first and second ends of the track assembly, the cow head assembly attached to the winch cable on one end and to the pulling cable on an opposed end, wherein when the brake assembly is disengaged the cow head begins to move toward the weight tower being pulled by the pulling cable and the weight;
(f) a horn assembly having two horns held apart by a separation means, the separation means providing a first biasing force to separate the horns and wherein the horns are moved closer together whenever a force is applied to the horns that is greater than the first biasing force; and
(g) a rewind mechanism, said rewind mechanism having
a pivotable rewind lever;
a motor assembly connected to the winch assembly such that the winch drum is rotated in the first direction whenever the motor assembly is activated;
a motor engagement cable connected to the rewind lever on one end and to the motor assembly on a second end, wherein when the rewind lever is pivoted the motor assembly is activated; and
a link connecting the motor assembly and the brake assembly, said link disengages the brake assembly whenever the motor assembly is activated.

20. A method for practicing team roping comprising:
(a) placing a saddle on a team roping device comprising
a horse assembly,
a pulling mechanism,
a track assembly having a first end and second end, wherein the track assembly extends from the horse assembly at the first end to the pulling mechanism at the second end,
a simulated cow head assembly reciprocably movable along a length of the track assembly between the first and second ends of the track assembly; and
a release mechanism for initiating movement of the cow head assembly along the length of the track assembly toward the second end of the track assembly;
(b) mounting the saddle;
(c) activating the release mechanism;
(d) roping the moving cow head assembly with a rope; and
(e) dallying the rope.

21. The method of claim 20, further comprising the step of returning the cow head assembly to its initial position.

22. A method for practicing team roping comprising:
(f) placing a saddle on a team roping device comprising
a horse assembly,
a pulling mechanism,
a track assembly having a first end and second end, wherein the track assembly extends from the horse assembly at the first end to the pulling mechanism at the second end,
a simulated cow head assembly reciprocably movable along a length of the track assembly between the first and second ends of the track assembly; and
a release mechanism for initiating movement of the cow head assembly along the length of the track assembly toward the second end of the track assembly;
(g) mounting the saddle;
(h) roping the cow head assembly with a rope;
(i) activating the release mechanism; and
(j) dallying the rope.
